(19) United States
(12) Patent Application Publication
(10) Pub. No.: US 2013/0227597 A1
(43) Pub. Date: Aug. 29, 2013

(54) PERSONAL PROGRAM CHANNEL

(71) Applicants: Arjun Baskaran, Chennai (IN); Saurabh Gorecha, Chennai (IN)

(72) Inventors: Arjun Baskaran, Chennai (IN); Saurabh Gorecha, Chennai (IN)

(73) Assignee: VERIZON PATENT AND LICENSING INC., Basking Ridge, NJ (US)

(21) Appl. No.: 13/407,803

(22) Filed: Feb. 29, 2012

(51) Int. Cl. H04N 21/258

(52) U.S. Cl. 725/14

(57) ABSTRACT

Method, device, and storage medium for receiving a request for a program from a user device; transmitting the program to the user device; storing tuning information associated with the request of the program; generating a program log that includes a user's viewing history based on the tuning information; analyzing the program log to identify programs of interest to the user; generating personal program channel information based on the analyzing, wherein the personal program channel information includes a schedule of programs; and providing to the user device a personal program channel that operates according to the schedule of programs.

### BACKGROUND

Program service providers, such as television service providers, offer users an array of programs to view and record. Typically, program service providers provide users with a program guide interface that indicates what program is being aired on a particular television channel and information about each program.

### DESCRIPTION OF THE DRAWINGS

FIG. 1 is a diagram illustrating an exemplary environment in which an exemplary embodiment of a personal program channel may be implemented;

FIGS. 2A and 2B are messaging diagrams pertaining to an exemplary process performed by an exemplary embodiment of a program delivery system;

FIG. 3 is a diagram illustrating exemplary information pertaining to an exemplary embodiment of a personal program channel;

FIG. 4 is a diagram illustrating exemplary components of a device that may correspond to one or more of the devices previously depicted; and

FIGS. 5A and 5B are flow diagrams illustrating an exemplary process for creating a personal program channel in an exemplary embodiment of a program delivery system.

### DETAILED DESCRIPTION

The following detailed description refers to the accompanying drawings. The same reference numbers in different drawings may identify the same or similar elements.

The term “program” includes video and/or audio content. For example, a program includes a program of a television channel, such as a local program, a national program, a television show, a movie, a sporting event, a news program, a musical event, a shopping program, a pay-per-view program, a video-on-demand program, a commercial, or an audio program (e.g., a program that plays music, a music channel that is of a particular musical genre, etc.). Additionally, for example, a program may include content from the Internet.

According to an exemplary embodiment, a program delivery system is provided that allows users to create personal program channels. According to an exemplary embodiment, the personal program channel includes a list of user-selected programs.

According to an exemplary embodiment, the program delivery system includes a receiving device. For example, the receiving device may be implemented as a set top box or other suitable device, as described further below. According to an exemplary embodiment, the receiving device captures tuning information indicating the programs viewed by a user.

According to an exemplary embodiment, the program delivery system includes a logging device. According to an exemplary embodiment, the logging device creates a program log based on the tuning information.

According to an exemplary embodiment, the program delivery system includes a program channel device. According to an exemplary embodiment, the program channel device analyzes the program log. For example, the program channel device identifies patterns of viewing of a user. According to an exemplary embodiment, the program channel device creates a personal program channel based on the analysis of the program log.

According to an exemplary embodiment, the program delivery system allows the user to modify the list of programs associated with the personal program channel. For example, the user may add a program or remove a program from the personal program channel.

According to an exemplary embodiment, the receiving device stores personal program channel information. According to an exemplary implementation, the personal program channel information includes a list of channels and times that are a schedule for the personal program channel. According to an exemplary embodiment, empty time slots of the personal program channel are filled with filler content (e.g., advertisement, video-on-demand movie trailers, scenes from an up-coming episode of a program series, etc.). The filler content may be selected based on identified user viewing habits and/or interests.

While exemplary embodiments provided in this description may be implemented based on the use of a particular protocol, network architecture, platform, etc., such implementations are not intended to be restrictive or provide an exhaustive treatment, as such. In other words, the embodiments described herein may be implemented using other suitable protocols, network architectures, platforms, etc., which may not be specifically described.

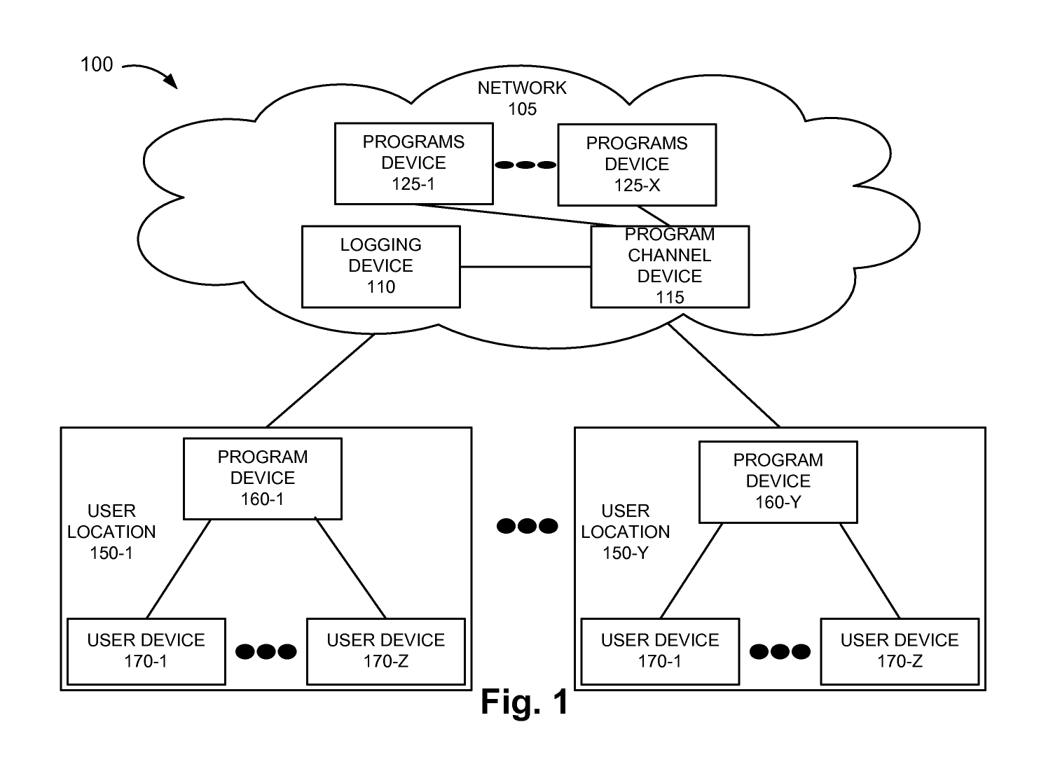

FIG. 1 is a diagram illustrating an exemplary environment in which an exemplary embodiment of a personal program channel may be implemented. As illustrated, an environment 100 includes a network 105. Network 105 includes a logging device 110, a program channel device 115, and programs devices 125-1 through 125-X, in which X>1 (also referred to collectively as programs devices 125 or individually as programs device 125). Environment 100 also includes user locations 150-1 through 150-Y, in which Y>1 (also referred to collectively as user locations 150 and individually as user location 150). User locations 150 includes program devices 160-1 through 160-Y, in which Y>1 (also referred to collectively as program devices 160 or individually as program device 160), and user devices 170-1 through 170-Z, in which Z>1 (also referred to collectively as user devices 170 or individually as user device 170).

The number of devices and networks, and the configuration in environment 100 are exemplary. According to other embodiments, environment 100 may include additional devices, fewer devices, different devices, and/or differently arranged devices, than those illustrated in FIG. 1. Additionally, or alternatively, environment 100 may include an additional network and/or a differently arranged network, than those illustrated in FIG. 1.

According to other embodiments, a single device in FIG. 1 may be implemented as multiple devices and/or multiple devices may be implemented as a single device. By way of example, user device 170 and program device 160 may be combined into a single device or logging device 110 and program channel device 1115 may be combined into a single device. According to another example, program device 160 may be implemented as multiple devices or logging device 110 may be implemented as multiple devices.

A device may be implemented according to a centralized computing architecture or a distributed computing architecture. Additionally, a device may be implemented according to one or multiple network architectures (e.g., a client device, a server device, a peer device, or a combination thereof).

Also, according to other embodiments, one or more functions and/or processes described as being performed by a particular device may be performed by a different device, or some combination of devices, which may or may not include the particular device.

Environment 100 may be implemented to include wired and/or wireless connections among the devices and network illustrated. A connection may be direct or indirect and may involve intermediary device(s) and/or network(s) not illustrated in FIG. 1. Additionally, the number and the arrangement of connections between the devices and the networks are exemplary.

Network 105 includes a network that provides programs to users. For example, network 105 includes a program delivery network. The program delivery network may provide at least one of a television service, a mobile service, or an Internet service. Network 105 may correspond to a satellite-based network and/or a terrestrial-based network. For example, network 105 may be implemented as a program streaming network, a program distribution network (e.g., a television delivery network), a mobile network, or devices in the Internet. Although not illustrated, network 105 may include, for example, billing devices, application servers, security devices, routing devices, program source devices, etc.

Logging device 110 includes a device that collects tuning information and creates program logs based on the tuning information. Logging device 110 may be implemented as, for example, a computational device, a server device, or other suitable network device. Logging device 110 is described further below.

Program channel device 115 includes a device that creates user-defined program channels. According to an exemplary embodiment, program channel device 115 creates user-defined program channels based on an analysis of program log information. Program channel device 115 may be implemented as, for example, a computational device, a server device, or other suitable network device. Program channel device 115 is described further below.

Programs device 125 includes a device that stores and/or manages the delivery of programs or other forms of content. According to an exemplary embodiment, programs device 125 provides program channel device 115 with a suggestion of programs or other content based on user information (e.g., a user profile, tuning information, a program log, etc.). Programs device 125 may be implemented as, for example, a computational device, a server device (e.g., an ad server device, a media managing server, etc.), a mass storage device, or other suitable network device. Programs device 125 is described further below.

User location 150 is a location of a user(s). For example, user location 150 may be a residence, a place of business, etc. User location 150 may include other devices not specifically illustrated, such as, a router device (e.g., an in-home router device, a broadband router, a wireless router, etc.), etc.

Program device 160 includes a device that interfaces with network 105 and user device 170. For example, program device 160 receives programs from network 105 and provides programs to user device 170. According to an exemplary embodiment, program device 160 generates tuning information that indicates a user's viewing behavior. Tuning information is described further below. Program device 160 may be implemented as, for example, a computational device (e.g., a computer), a server device (e.g., a media server device, etc.), a set top box, or other suitable device. The term “set top box” may include, for example, a converter box, a television receiver, a tuner device, a digibox device, an Internet Protocol (IP) set top box, an IPTV set top box, and/or some other type of device capable of performing processes described herein.

User device 170 includes a device that communicates with network 105 via program device 160. For example, user device 170 may be implemented as a mobile device (e.g., a smartphone, a tablet device, a personal digital assistant (PDA), a personal communication system (PCS), etc.). Additionally, for example, user device 170 may be implemented as a television, a remote control device, and a set top box, or a computer (e.g., a desktop computer, a laptop computer, a palmtop computer, a netbook, etc.), a game system (e.g., a PS3® device, etc.), or other types of user devices capable of receiving programs.

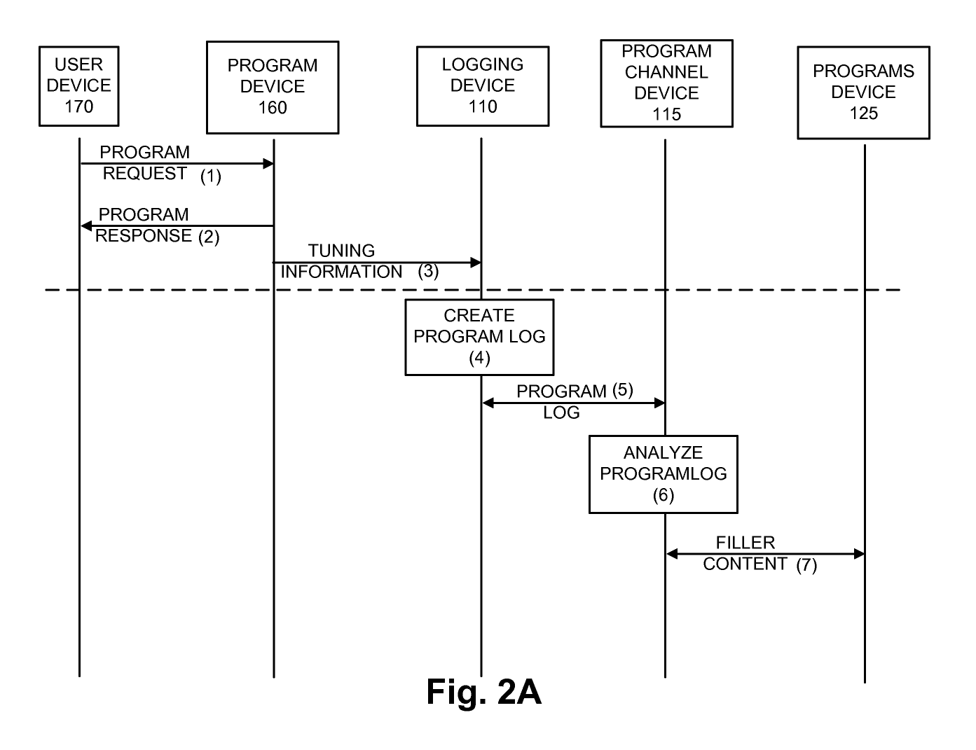

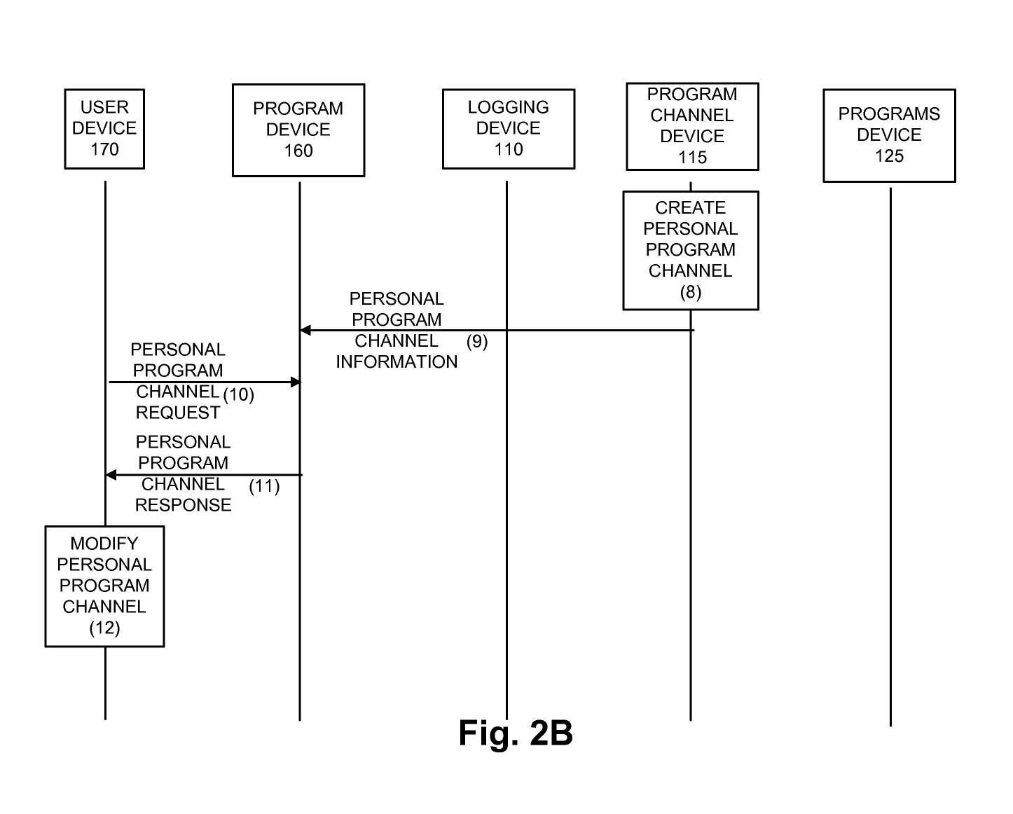

FIGS. 2A and 2B are messaging diagrams of an exemplary process performed by an exemplary embodiment of a program delivery system. The exemplary process is described in relation to the devices illustrated in environment 100 of FIG. 1. For purposes of description, it may be assumed that user device 170 has established a connection with program device 160. For example, user device 170 may establish a connection with program device 160 based on a discovery process. According to an exemplary implementation, as described further below, program device 160 may obtain user device information pertaining to user device 170 during a connection process.

The messages described and the data or information included therein are merely exemplary. According to other implementations, the program delivery system may use different types of messages and/or include different data or information. Additionally, or alternatively, although the exemplary process describes a particular device performing a step or act of the process, the step or act may, alternatively be performed by another device, or some combination of devices.

Referring to FIG. 2A, in step (1), user device 170 transmits a program request to program device 160. For example, in the case of user device 170 implemented as a set top box, the program request includes a television channel identifier corresponding to a television channel to which the user has tuned. In step (2), in response to receiving the program request, program device 160 transmits a program response to user device 170. For example, in the case of program device 160 implemented as a media server, program device 160 tunes to the requested television channel and provides the program to user device 170. In step (3), program device 160 transmits tuning information to logging device 110. For example, the tuning information includes the television channel number, a program identifier, a date and time stamp, and a device identifier (e.g., a program device identifier, a user device identifier, a user identifier (e.g., a user name, etc.), a network address (e.g., an IP address, a Media Access Control (MAC) address, etc.)). As indicated by the dashed line, steps (1) through (3) may be repeated numerous times over a configurable time period (e.g., a few days, a week, etc.) before a program log and/or a personal program channel is created. According to an exemplary embodiment, tuning information includes recorded program viewing information. For example, the recorded program viewing information includes information pertaining to programs recorded using a digital video recorder (DVR) service and/or viewed by the user.

In step (4), logging device 110 collects tuning information from program device 160. For example, logging device 110 stores a database or a data structure that includes tuning information. Logging device 110 creates a program log based on the tuning information. According to an exemplary embodiment, logging device 110 includes pre-processing analytics that are used to pre-process the tuning information. For example, logging device 110 may filter tuning information that relates to channel surfing by the user or the tuning of a program for a brief period (e.g., a configurable time parameter).

In step (5), program channel device 115 obtains the program log. For example, logging device 110 transmits the program log to program channel device 115 or program channel device 115 retrieves the program log from logging device 110. In step (6), program channel device 115 analyzes the program log. According to an exemplary embodiment, program channel device 115 identifies a user's viewing pattern. As an example, program channel device 115 identifies programs watched and the frequency in which the user watches the identified programs. According to an exemplary embodiment, program channel device 115 correlates programs watched by the user with other programs that are similar based on, for example, genre and/or sub-genre of a program, an actor or an actress starring in the program, popularity of the program, and other program characteristics (e.g., date of a program, etc.).

In step (7), program channel device 115 communicates with programs devices 125 to identify filler content. According to an exemplary embodiment, the filler content is selected based on the user's viewing pattern and other user-related information. For example, the other user-related information may include subscriber information (e.g., including user demographics, such as age, location of user (e.g., zip code, etc.), marital status, etc.) and other forms of a user's usage of a program service. For example, a television service typically provides an interactive programming guide (IPG) that includes various menus and access to other content, such as games. The interactive programming guide may also include other menus to allow the user to perform other activities, such as shopping (e.g., a marketplace menu).

As previously described, the filler content is selected based on the user's viewing pattern and other user-related information. According to an exemplary embodiment, program channel device 115 generates a user profile that includes information indicating a representation of the user's interest. The user profile is used to select the filler content. For example, program channel device 115 provides the user profile to programs device 125. Programs device 125 searches and selects programs or other content based on the user profile. Alternatively, program channel device 115 performs this task based on the generated user profile. As an example, program channel device 115 searches programs or other content and selects commercials, movie trailers, behind-the-scenes programs, etc., which correlate with the user profile.

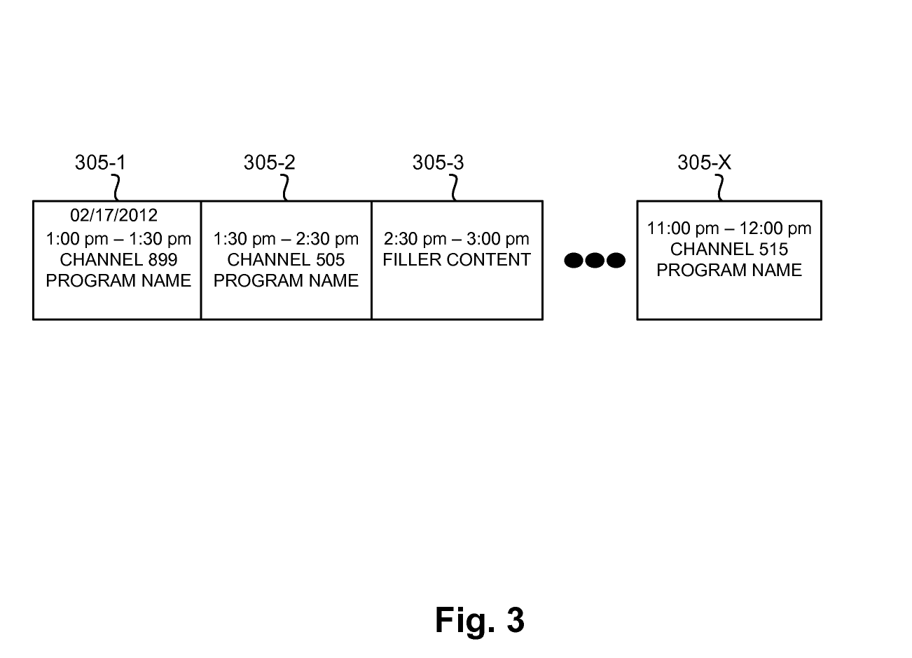

Referring to FIG. 2B, in step (8), program channel device 115 creates a personal program channel based on the selected programs and the filler content. The personal program channel includes a schedule of programs and filler content. For example, as illustrated in FIG. 3, the personal program channel provides the user with a series of program blocks 305-1 through 305-X that indicates times, channels, and programs or filler content. Given the different types of programs, as an example, a program may be a program that airs only once (e.g., a movie) or a program may be a program series that airs regularly on one or multiple channels, every day, one time a week, etc. For example, assume the user has watched a first episode of a program series, which is included in the tuning information. The personal program channel will include a future episode (e.g., the second episode, a third episode, etc.) of the program series. In step (9), program channel device 115 transmits personal program channel information to program device 160.

In step (10), user device 170 transmits a program request (e.g., a personal program channel request) to program device 160. For example, the user selects the personal program channel via a remote control device that includes a channel selector. Alternatively, the user may access the personal program channel via a user interface (e.g., an IPG), as described further below. In step (11), program device 160 provides a scheduled program to user device 170 based on the personal program channel information. The user may then continuously watch programs and filler content provided on the personal program channel without use of a remote control device or having to change channels via some other method. For example, according to an exemplary embodiment, program device 160 tunes to programs that are aired on a particular channel and provides these programs on the personal program channel. According to an exemplary implementation, and referring back to FIG. 3, assume the personal program channel is provided via a television service, and a program is being aired on channel 899 (e.g., program block 305-1). The user tunes to channel 500 on user device 170 (e.g., a set top box). Channel 500 is the channel number of the user's personal program channel. Program device 160 tunes to channel 899 and provides the program on channel 500. According to another embodiment, the user does not tune to a personal program channel number (e.g., 500). Rather, the user selects via a user interface of user device 170, a button of a remote control device, etc, that indicates the user wishes to view programs selected for his/her personal program channel. Program device 160 receives this request or selection and tunes to the channels indicated in program block 305-1 and the set top box automatically tunes to the same channel (e.g., 899).

In step (12), the user, via user device 170, may modify the programming associated with the personal program channel. According to an exemplary embodiment, the user is provided with a user interface to add and remove programs and filler content from the personal program channel. By way of example, the user interface may be implemented within the interactive programming guide or other user interface available in a menu system. For example, the user may remove a program, a reoccurring program series, and add a program, a reoccurring program series, etc. Additionally, the user interface may permit the user to add or remove a program or filler content for a specified time period (e.g., a day, a week, a month, forever). The user may select a program to add from programs included in the interactive programming or other menus (e.g., video-on-demand menus, pay-per-view menus, etc.). Program channel device 115 updates the personal program channel based on the added and/or removed programs.

The program delivery system may also modify the programming associated with the personal program channel based on the user's usage of the personal program channel. For example, when the user stops watching the personal program channel and begins watching another channel or program, the tuning information (or detuning information) is provided to logging device 110 and program channel device 115 updates the personal program channel.

Additionally, according to an exemplary embodiment, program channel device 160 monitors the user's viewing behavior while the user is watching the personal program channel based on the program logs. For example, program channel device 160 stores the amount of time the user watched the personal program channel over a time period (e.g., daily, weekly, monthly), stores the number of programs watched on the personal program channel over a time period (e.g., daily, weekly, monthly), and stores which programs offered on the personal program channel are viewed by the user. Based on the analysis of this information, program channel device 160 continuously evaluates the programs offered to the user via the personal program channel schedule.

Additionally, according to an exemplary embodiment, program channel device 160 may store user interest values pertaining to programs that the user consistently watches on the personal program channel (e.g., over a configurable time period). The user interest value may be interpreted by program channel device 160 as an indication of a strength of the user's interest in these programs. Program channel device 160 updates the personal program channel information based on the reinforcement values. For example, program channel device 160 selects similar programs to be included in the personal program channel based on programs having user interest values that are higher than other programs. Additionally, program channel device 160 may remove programs from the personal program channel that have low user interest values and similar programs that were selected based on such programs.

While FIGS. 2A and 2B are messaging diagrams pertaining to an exemplary process performed by an exemplary embodiment of a program delivery system, according to other scenarios, the message(s) transmitted and/or received may be different, and/or the step(s) or act(s) described may be different.

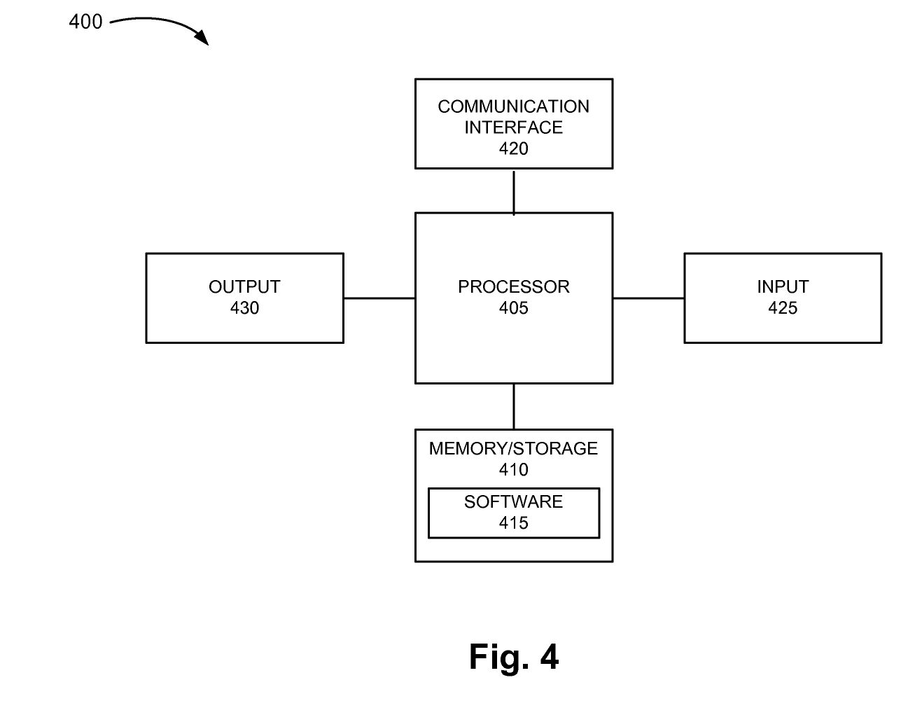

FIG. 4 is a diagram illustrating exemplary components of a device 400 that may correspond to one or more of the devices depicted in the previous Figures. As illustrated, according to an exemplary embodiment, device 400 includes a processor 405, memory/storage 410, software 415, a communication interface 420, an input 425, and an output 430. According to other embodiments, device 400 may include fewer components, additional components, different components, and/or a different arrangement of components than those illustrated in FIG. 4 and described herein.

Processor 405 may include one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (e.g., one or multiple cores), microcontrollers, and/or some other type of component that interprets and/or executes instructions and/or data. Processor 405 may be implemented as hardware (e.g., a microprocessor, etc.), a combination of hardware and software (e.g., a SoC, an ASIC, etc.), may include one or multiple memories (e.g., memory/storage 410), etc.

Processor 405 may control the overall operation or a portion of operation(s) performed by device 400. Processor 405 may perform one or multiple operations based on an operating system and/or various applications or programs (e.g., software 415). Processor 405 may access instructions from memory/storage 410, from other components of device 400, and/or from a source external to device 400 (e.g., a network, another device, etc.).

Memory/storage 410 may include one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a phase-change memory (PCM), a dual in-line memory module (DIMM), a flash memory, and/or some other type of memory. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray® disk (BD), etc.). Memory/storage 410 may store data, software, and/or instructions related to the operation of device 400.

Software 415 may include an application or a program that provides a function and/or a process. Software 415 may include firmware. For example, program device 160 and/or bandwidth broker 155 may be implemented as one or more program(s) and/or application(s). Additionally, for example, with reference to user device 170, one or more program(s) and/or application(s) may be used to display user interfaces, communicate with program device 160, etc. Additionally, for example, other devices may be implemented with software 415 to provide a function and/or a process described herein.

Communication interface 420 may permit device 400 to communicate with other devices, networks, systems, etc. Communication interface 420 may include one or multiple wireless interfaces and/or wired interfaces. Communication interface 420 may include one or multiple transmitters, receivers, and/or transceivers. Communication interface 420 may operate according to one or multiple protocols, standards, and/or the like.

Input 425 may permit an input into device 400. For example, input 425 may include a keyboard, a mouse, a display, a touchscreen, a touchless screen, a button, a switch, an input port, speech recognition logic, and/or some other type of visual, auditory, tactile, etc., input component. Output 430 may permit an output from device 400. For example, output 430 may include a speaker, a display, a touchscreen, a touchless screen, a light, an output port, and/or some other type of visual, auditory, tactile, etc., output component.

Device 400 may perform processes and/or functions, as described herein, in response to processor 405 executing software 415 stored by memory/storage 410. By way of example, instructions may be read into memory/storage 410 from another memory/storage 410 or from another device via communication interface 420. The instructions stored by memory/storage 410 may cause processor 405 to perform one or more processes described herein. Alternatively, for example, according to other implementations, device 400 may perform one or more processes described herein based on the execution of hardware (processor 405, etc.), the execution of firmware with hardware, or the execution of software and firmware with hardware.

According to an exemplary embodiment, program device 160 receives programs from a network device (e.g., a media server, etc., not illustrated in FIG. 1) associated with network 105. Program device 160 may comprise tuners that permit program device 160 to tune to particular programs or television channels requested by users via user devices 170.

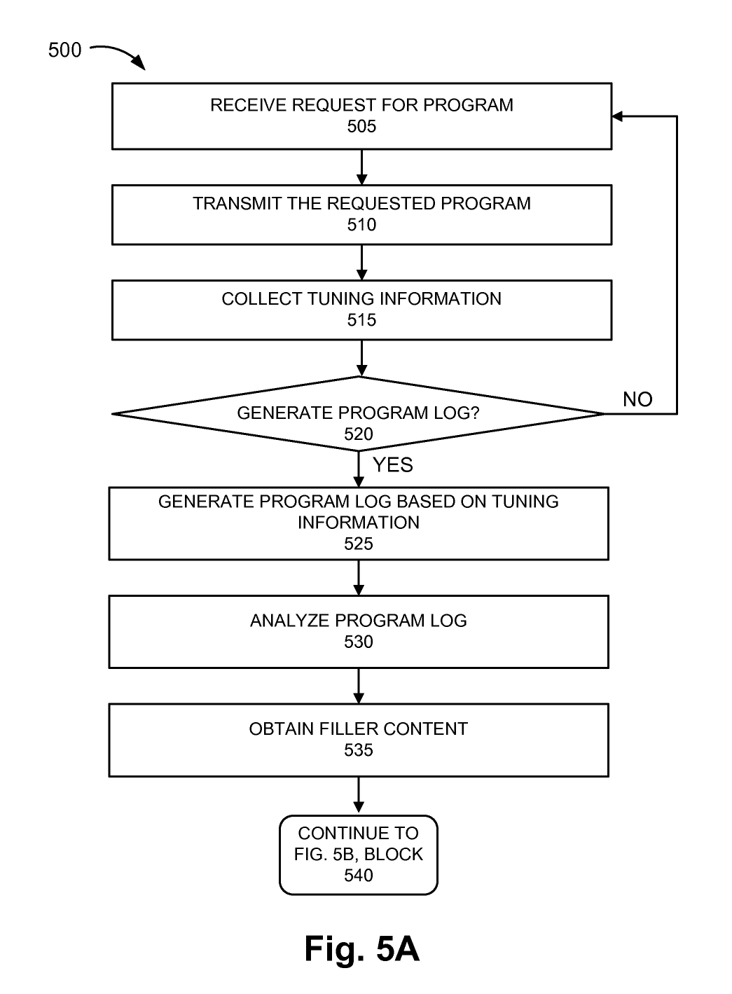

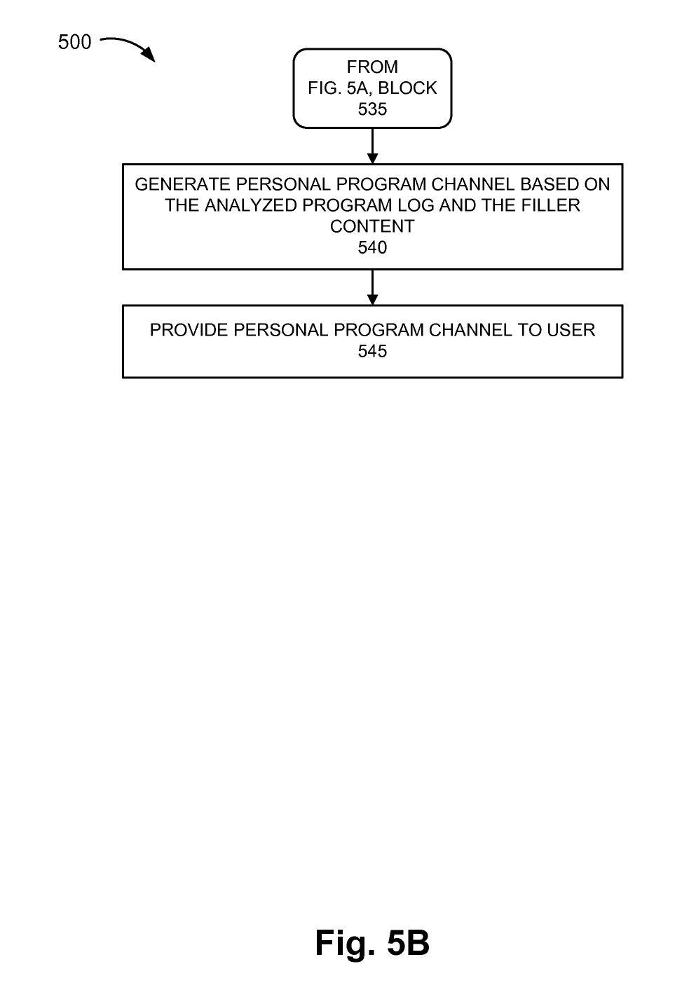

FIGS. 5A and 5B are flow diagrams illustrating an exemplary process 500 for creating a personal program channel in an exemplary embodiment of a program delivery system. A step described in process 500 is performed by one of the devices illustrated in FIG. 1. For example, processor 405 may execute software 415 to perform the step described.

Process 500 begins with receiving a request for a program (block 505). For example, program device 160 receives a request for a program from a user via user device 170.

In block 510, the requested program is transmitted. For example, program device 160 provides the program to the user via user device 170.

In block 515, tuning information is collected. For example, program device 160 collects tuning information pertaining to the user's viewing behavior. For example, as previously described, the tuning information includes the television channel number, a program identifier, a date and time stamp, and a device identifier. According to other implementations, the tuning information may include additional, different, and/or fewer types of data or information. Additionally, for example, tuning information may pertain to a user's viewing behavior on the Internet. For example, a television service provider may offer access to programs (e.g., on-demand) to users via a web site. The user is identified based on login information. The user then selects a program to watch via a computer or a mobile device. According to such an example, the tuning information may include the date and time and a program identifier. The web server device or program streaming/downloading device hosting this service may provide the tuning information to logging device 110.

In block 520, it is determined whether to generate a program log. According to an exemplary embodiment, in order to establish a user's interest or pattern of viewing, a sufficient amount of tuning information may need to be collected. Program device 160 or logging device 110 may determine whether a program log is to be generated based on, for example, a configurable time period for collecting tuning information (e.g., a day, several days, a week) and/or some other configurable parameter (e.g., a threshold number of programs viewed, etc.). If it is determined that a program log is not to be generated (block 520-NO), then process 500 continues to block 505. For example, process continues to collect tuning information pertaining to the user's viewership. If it is determined that a program log is to be generated (block 520—YES), then a program log is generated based on the tuning information (block 525). For example, logging device 110 generates a program log based on the collected tuning information. According to an exemplary embodiment, as previously described, the generation of the program log includes filtering out tuning information that does not reflect a user's interests.

In block 530, the program log is analyzed. For example, logging device 110 provides the program log to program channel device 115. Program channel device 115 analyzes the program log. For example, as previously described, program channel device 115 identifies programs watched by the user and selects similar programs.

In block 535, filler content is obtained. For example, program channel device 115 communicates with programs devices 125 to obtain filler content. The filler content is selected based on the user's viewing pattern and other user-related information, as previously described. According to an exemplary embodiment, program channel device 115 generates a user profile that includes information indicating a representation of the user's viewing interests.

Referring to FIG. 5B, in block 540, a personal program channel is generated based on the analyzed program log and the obtained filler content. For example, program channel device 115 generates a personal program channel. The personal program channel includes a schedule of programs and filler content.

In block 545, the personal program channel is provided to the user. For example, program channel device 115 transmits personal program channel information to program device 160. The user may then access the personal program channel via his/her user device 170. Additionally, for example, the personal program channel information may be stored on a web server device.

Although FIGS. 5A and 5B illustrates an exemplary process 500 to create a personal program channel, process 500 may include additional operations, fewer operations, and/or different operations than those illustrated in FIGS. 5A and 5B and described herein.

The foregoing description of embodiments provides illustration, but is not intended to be exhaustive or to limit the embodiments to the precise form disclosed. Accordingly, modifications to the embodiments described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks have been described with regard to the process illustrated in FIGS. 5A and 5B, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software, firmware, and/or hardware. For example, a process or a function may be implemented as “logic” or as a “component.” This logic or this component may include hardware (e.g., processor 405, etc.), a combination of hardware and software (e.g., software 415), a combination of hardware and firmware, or a combination of hardware, firmware, and software. The embodiments have been described without reference to the specific software code since software can be designed to implement the embodiments based on the description herein.

Additionally, embodiments described herein may be implemented as a non-transitory storage medium that stores data and/or information, such as instructions, program code, data structures, program modules, an application, etc. For example, a non-transitory storage medium includes one or more of the storage mediums described in relation to memory/storage 410.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction described in the present application should be construed as critical or essential to the embodiments described herein unless explicitly described as such.

What is claimed is:

1. A method comprising:
receiving a request for a program from a user device associated with a user;
transmitting the program to the user device;
storing tuning information associated with the request of the program;
determining whether a program log is to be generated, wherein the determining is based on one of a time-based parameter or a threshold number of programs viewed by the user;
transmitting the program log to a logging device, in response to determining that the program log is to be generated;
generating a program log that includes a user's viewing history, based on the tuning information, wherein the generating includes filtering out tuning information that does not indicate an interest of the user;
transmitting the program log to a program channel device;
analyzing the program log to identify programs of interest to the user;
generating personal program channel information based on the analyzing, wherein the personal program channel information includes a schedule of programs; and
providing to the user device a personal program channel that operates according to the schedule of programs.

2. The method of claim 1, further comprising:
selecting filler content that matches an interest of the user based on the identified programs; and
including filler content information in the personal program channel information that indicates filler content to be provided during empty timeslots of programming.

3. The method of claim 1, wherein the tuning information includes a date and time stamp for each instance of a request for a program and at least one of a television channel number or a program identifier.

4. The method of claim 1, further comprising:
generating a user profile that includes information indicating the user's interest in programs.

5. The method of claim 1, further comprising:
receiving a user selection to add or remove one or more programs scheduled to be provided by the personal program channel; and
adding or removing the one or more programs to or from the personal program channel.

6. The method of claim 1, further comprising:
displaying the schedule of programs of the personal program channel in an interactive programming guide.

7. The method of claim 1, wherein the schedule of programs includes a schedule of future episodes of a television program series.

8. The method of claim 1, further comprising:
continuing to collect and store tuning information, without generating the program log, in response to determining that the program log is not to be generated based on the one of the time-based parameter or the threshold number of programs viewed.

9. A program delivery system comprising:
a program device;
a logging device; and
a program channel device;
the program device comprising:
a first communication interface;
a memory that stores first instructions; and
a first processor to execute the first instructions to:
receive, via the first communication interface, requests for programs from a user device associated with a user;
deliver, via the first communication interface, the programs to the user device, in response to the requests;
store tuning information pertaining to the programs; and
provide, via the first communication interface, the tuning information to the logging device;
the logging device comprising:
a second communication interface;
a memory that stores second instructions; and
a second processor to execute the second instructions to:
generate a program log that represents the user's viewing program history based on the tuning information; and
provide, via the second communication interface, the program log to a program channel device;
the program channel device comprising:
a third communication interface;
a memory that stores third instructions; and
a third processor to execute the third instructions to:
analyze the program log;
identify programs that are of interest to the user;
generate personal program channel information, wherein the personal program channel information includes a schedule of the identified programs; and
provide, via the third communication interface, the personal program channel information to the program device.

10. The program delivery system of claim 9, wherein, when identifying programs, the third processor further executes the third instructions to:
identify programs similar to the programs delivered to the user device; and wherein, when generating the personal program channel information, the third processor further executes the third instructions to:
generate the personal program channel information based on the similar, identified programs, wherein the schedule of the identified programs includes a schedule of the similar, identified programs.

11. The program delivery system of claim 9, wherein the second processor further executes the second instructions to:
filter out tuning information indicating the user's channel surfing of programs, and wherein, when generating the program log, the second processor further executes the second instructions to:
generate the program log based on tuning information that is not filtered out.

12. The program delivery system of claim 9, wherein the first processor further executes the first instructions to:
receive, via the first communication interface, a request for the user's personal program channel from the user device;
deliver, via the first communication interface, one or more programs to the user device, in response to the request and according to the personal program channel information;
store detuning information pertaining to a request from the user, via the user device, to view another program channel or a program not offered by the user's personal program channel, wherein the detuning information includes a date and time stamp of the request and at least one of a television channel number or a program identifier pertaining to the requested other program channel or the program to which the user requested; and
update the personal program channel information based on the detuning information.

13. The program delivery system of claim 9, wherein the first processor of the program device further executes the first instructions to:
deliver, via the first communication interface, the identified programs to the user device according to the schedule of the identified programs, in response to a request from the user device for the user's personal program channel.

14. The program delivery system of claim 9, wherein the personal program channel information includes a schedule of future programming offered via a television delivery service.

15. The program delivery system of claim 9, wherein the third processor of the program channel device further executes the third instructions to:
obtain filler content that is of interest to the user; and
combine a schedule of the filler content with the schedule of the identified programs.

16. The program delivery system of claim 9, wherein the program device includes an in-home media server device associated with a television delivery system.

17. A non-transitory storage medium storing instructions executable by a computational device, wherein the instructions comprise instructions to:
store tuning information pertaining to requests for programs from a user device associated with a user;
transmit the tuning information to another device;
receive and store personal program channel information that includes a schedule of programs identified as being of interest to the user based on the tuning information; and
transmit the identified programs to the user device according to the schedule of the identified programs, in response to a request from the user device for the user's personal program channel.

18. The non-transitory storage medium of claim 17, wherein the tuning information includes a date and time stamp for each instance of a request for a program and at least one of a television channel number or a program identifier.

19. The non-transitory storage medium of claim 17, wherein the instructions comprise instructions to:
receive a user selection to add or remove one or more of the identified program from the user's personal program channel; and
receive updated personal program channel information based on the user-selected one or more identified programs.

20. The non-transitory storage medium of claim 17, wherein the instructions comprise instructions to:
determine whether a program log is to be generated, wherein the determining is based on one of a time-based parameter or a threshold number of programs viewed associated with the tuning information.
